(19) United States
(12) Patent Application Publication
(10) Pub. No.: US 2018/0011994 A1
(43) Pub. Date: Jan. 11, 2018

(54) Earpiece with Digital Rights Management

(71) Applicant: BRAGI GmbH, München (DE)

(72) Inventor: Peter Vincent Boesen, München (DE)

(73) Assignee: BRAGI GmbH, München (DE)

(21) Appl. No.: 15/623,692

(22) Filed: Jun. 15, 2017

Related U.S. Application Data
(60) Provisional application No. 62/359,060, filed on Jul. 6, 2016.

(51) Int. Cl. G06F 21/12; G06F 21/60; G06F 3/16; G06F 21/32; H04R 1/10

(52) U.S. Cl. CPC G06F 21/121; G06F 21/32; H04R 1/1041; H04R 1/1016; G06F 3/165; G06F 21/602; H04R 2420/07; G06F 2221/0797

(57) ABSTRACT

A wireless earpiece for digital rights management is provided. The wireless earpiece includes a processor disposed within the ear piece housing, a speaker operatively connected to the processor, a storage medium disposed within the ear piece housing and operatively connected to the processor, and a wireless transceiver disposed within the ear piece housing and operatively connected to the processor. The processor may be configured to access audio files stored on the storage medium to play the audio files over the speaker. The processor may be configured to provide a digital rights management feature for one or more of the audio files. The processor may be further configured to access an audio stream conveyed to the earpiece through the wireless transceiver. The processor may be further configured to provide a digital rights management for the audio stream.

### PRIORITY STATEMENT

This application claims priority to U.S. Provisional Patent Application 62/359,060, filed on Jul. 6, 2016, and entitled Earpiece with Digital Rights Management, hereby incorporated by reference in its entirety.

### FIELD OF THE INVENTION

The present invention relates to ear pieces. More particularly, but not exclusively, the present invention relates to ear pieces which reproduce audio and provide digital rights management (DRM) features.

### BACKGROUND

Earpieces may be used for playing stored audio directly to a user or streaming audio. What is needed is an improved earpiece which provides for digital rights management of audio stored on the earpiece and/or audio streamed to the earpiece.

### SUMMARY

Therefore, it is a primary object, feature, or advantage of the present invention to improve over the state of the art.

It is a further object, feature, or advantage of the present invention to provide an earpiece with digital rights management.

It is a still further object, feature, or advantage of the present invention to provide an earpiece which stores audio files and provides digital rights management.

Another object, feature, or advantage is to provide an earpieces which receives streaming audio and provides for digital rights management.

Yet another object, feature, or advantage is to provide a link between one or more earpieces and a media subscription account.

A still further object, feature, or advantage is to authorize a user based on biometric data for access to a media subscription account.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by an objects, features, or advantages stated herein.

According to one aspect, a wireless earpiece for digital rights management is provided. The wireless earpiece includes a processor disposed within the ear piece housing, a speaker operatively connected to the processor, a storage medium disposed within the ear piece housing and operatively connected to the processor, and a wireless transceiver disposed within the ear piece housing and operatively connected to the processor. The processor may be configured to access audio files stored on the storage medium to play the audio files over the speaker. The processor may be configured to provide a digital rights management feature for one or more of the audio files. The processor may be further configured to access an audio stream conveyed to the earpiece through the wireless transceiver. The processor may be further configured to provide a digital rights management for the audio stream. The wireless earpiece may further include at least one sensor for detecting biometric information, the at least one sensor operatively connected to the processor. The processor may be configured to verify an identity of a user using the biometric information from the at least one sensor. The audio files may be encrypted and the digital rights management feature may provide for unencrypting the audio files for playback through the speaker if the wireless earpiece is authorized. Whether or the not the wireless earpiece is authorized or not may be determined using a device identifier associated with the wireless earpiece, or biometric information of a user, or login information or authorization code(s) of a user.

According to another aspect, a method for using digital rights management in an earpiece is provided. The method includes providing an earpiece comprising an ear piece housing, a processor disposed within the ear piece housing, a speaker operatively connected to the processor, a storage medium disposed within the ear piece housing and operatively connected to the processor, and a wireless transceiver disposed within the ear piece housing and operatively connected to the processor. The method further includes unencrypting an audio file or an audio stream at the earpiece to provide for digital rights management, the method further includes playing the audio file or the audio stream using the speaker. The step of unencrypting may be performed using a device identifier for the earpiece. The step of unencrypting may be performed using a user identifier associated with a user of the earpiece. The identity of the user is verified using biometric data from at least one sensor operatively connected to the processor.

### BRIEF DESCRIPTION OF THE DRAWINGS

FIG. 1 illustrates a set of earpieces with digital rights management.

FIG. 2 illustrates an earpiece with digital rights management.

FIG. 3 is a block diagram illustrating an earpiece with digital rights management.

FIG. 4 illustrates one embodiment of a system for digital rights management.

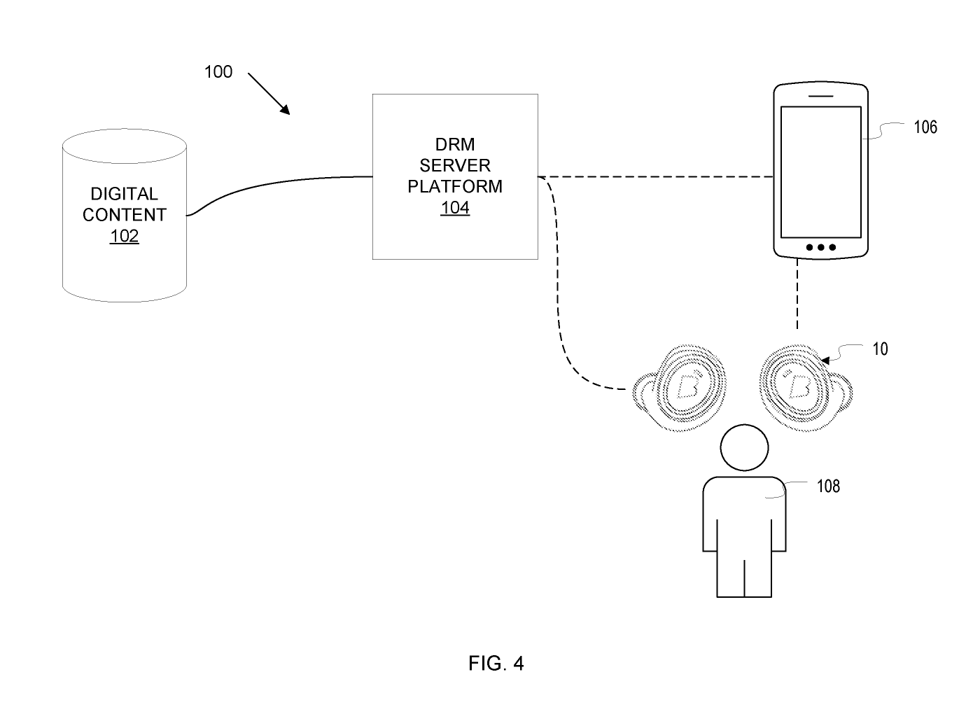

### DETAILED DESCRIPTION

An earpiece or set of earpieces is provided which include digital rights management (DRM). The earpieces can access media in various ways. For example, the earpieces may include onboard storage which may be used to store media files such as audio files. When the audio files are stored onboard one or more earpieces, the audio files may be stored in an encrypted format to provide DRM controls. In one embodiment, the encrypted audio files may only be accessed when the earpiece or earpieces are registered with a DRM service. The earpieces may also provide for wireless communications which allow for receiving streaming audio. The audio stream may be protected with DRM controls through encryption or otherwise which allow the audio stream to only be accessible when the earpiece or earpieces are registered with the DRM service. Alternatively, the audio stream may be protected with DRM controls through encryption or otherwise which allow the audio stream to only be accessible when a user of the earpiece or earpieces is logged-in or granted access to an account and the audio stream is provided through the account.

It is contemplated that the digital rights management (DRM) used by the earpieces may allow for, be compatible with, or a part of any number of services including audio streaming services including like those from Spotify, Pandora, Google, Apple, Amazon, or others. Such devices may provide for limiting the number of devices which may be associated to a particular user or requiring authorization of a user account of the user. It is contemplated that the earpieces may count as a device. For example, when a song is stored on an earpiece, the earpiece may be considered a device and the song may be accessed or played only if the device is authorized.

According to another aspect, the earpiece may provide for verifying identity of a user using biometric information. Thus, instead of or an addition to authorizing a particular device through DRM, authorization can be provided by verifying the identity of a person who is an account holder for the services.

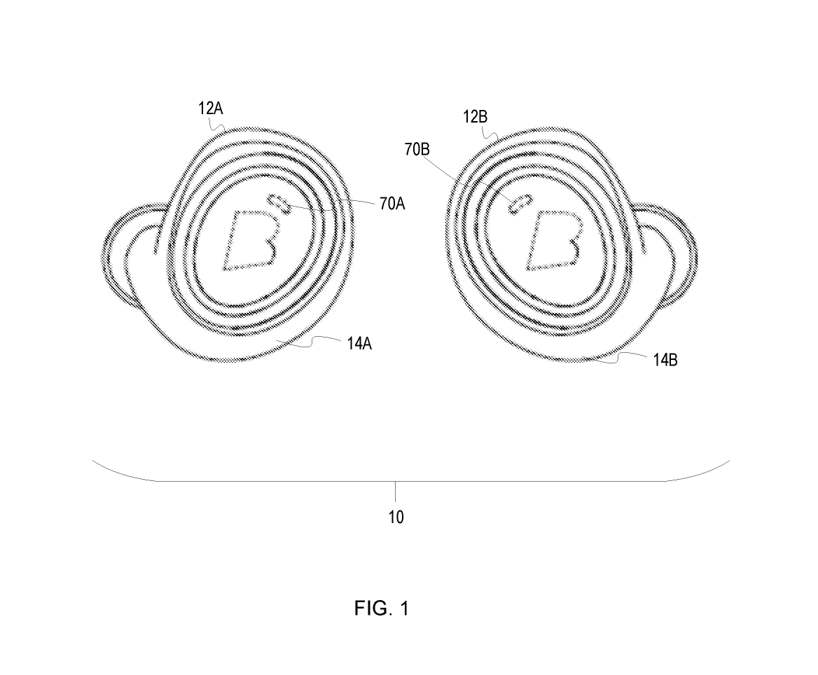

FIG. 1 illustrates a set of earpieces 10 including a left earpiece 12A and a right earpiece 12B. The left earpiece 12A has a housing or casing 14A and the right earpiece 12B has a housing or casing 14B. A microphone 70A is shown on the left earpiece 12A and a microphone 70B is shown on the right earpiece 12B. The ear pieces may be water proof and suited for use in any number of different athletic or sporting activities. The earpieces may be used for playing audio streams or for playing stored audio such as music which may be protected with digital rights management (DRM) protections.

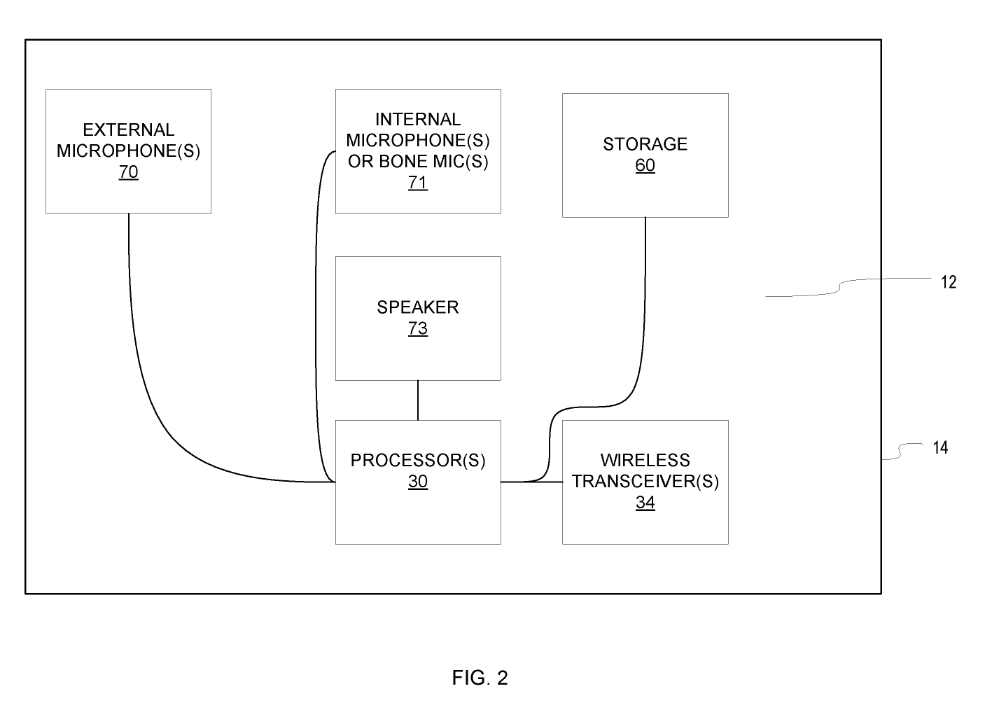

FIG. 2 illustrates an earpiece 12 which may be a left earpiece or a right earpiece. One or more processors or other intelligent controls 30 are shown disposed within the housing 14 of the earpiece. One or more wireless transceivers 34 are operatively connected to the processors 30. The term “processor” as used herein means a single processor or more than one processor in operative communication. The processor may include a digital signal processor, a microprocessor and/or other types of processors. The term intelligent control is used herein to encompass one or more processors. The wireless transceivers 34 may include a BLUETOOTH transceiver, an ultra-wideband (UWB) transceiver, a WiFi transceiver, or other type of radio transceiver, a near field magnetic induction (NFMI) transceiver, or other type of transceiver. One or more external microphones 70 is operatively connected to the processors 30 as are one or more internal microphones or bone microphones 71. Storage 60 is disposed within the housing 14 of the earpiece 12. The storage 60 may be a machine readable or computer readable non-transitory storage medium. For example, the storage 60 may be a solid state memory or flash memory.

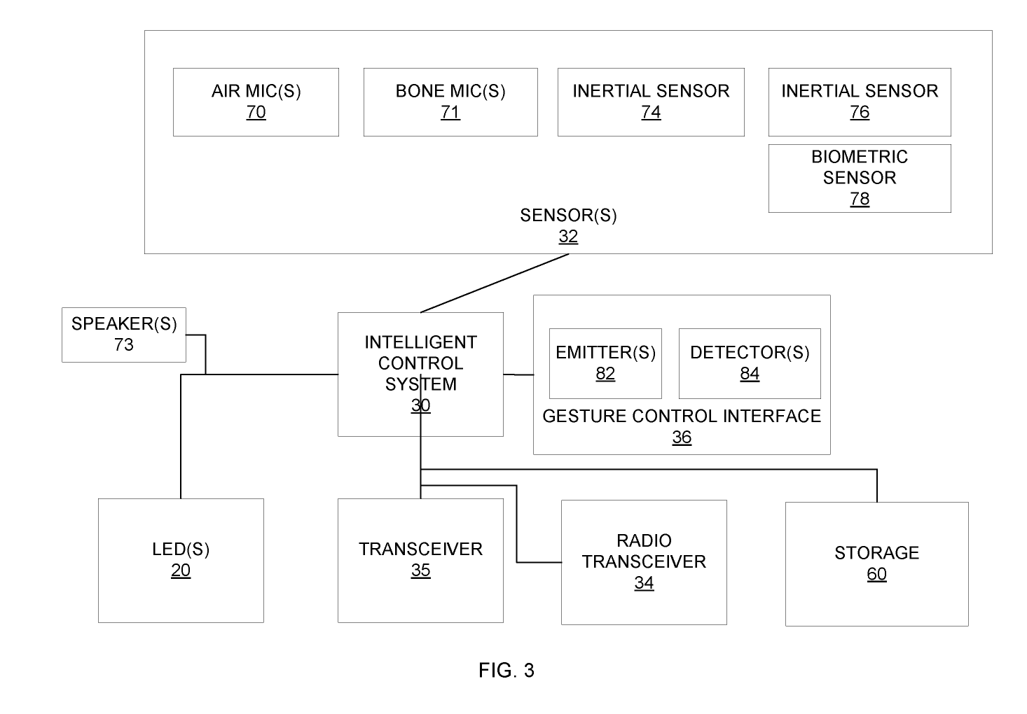

FIG. 3 is a block diagram illustrating an earpiece. The earpiece may include one or more sensors 32. The sensors may include one or more air microphones 70, one or more bone microphones 71, one or more inertial sensors 74, 76, and one or more biometric sensors 78. Each of the one or more sensors 32 is operatively connected to an intelligent control system 30. The intelligent control system 30 may also be operatively connected to a gesture control interface 36 which may include one or more emitters 82 and one or more detectors 84. The gesture control interface 36 allows a user to interact with the earpiece through gestures or motions which are detected by the gesture control interface and interpreted by the intelligent control system 30. One or more speakers 72 is operatively connected to the intelligent control system 30. One or more light emitting diodes 20 are operatively connected to the intelligent control system 30 that may be used to provide visual feedback indicative of earpiece functionality or status. A radio transceiver 34 is shown as well as a second transceiver 35 which may be an NFMI transceiver or other type of transceiver. Onboard storage 60 is operatively connected to the intelligent control system 30.

The one or more biometric sensors 78 as well as the other sensors, in some embodiments, allow for biometric information to be sensed which may be used in identifying a user. For example, voice input may be used to match a user to a voice footprint. If the biometric sensor 78 is a finger printer sensor, a user may be identified using their fingerprint. Other types of biometric sensors 78 may also be used. For example, where the biometric sensors include a heart rate sensor or pulse oximeter, heart rate information indicative of heart rate variability may be determined and used to identify a user. In order to gain access to content or media including audio content or music which is protected through digital rights management, an identifier associated with the particular earpiece device may be used, such as a serial number. Alternatively, in order to gain access to content or media including audio content or music which is protected through digital rights management, an identity of a user may be used. Alternatively, one or both may be used. For example, access may be provided to a particular user regardless of the particular earpieces that are being used, access may be provided to a particular device (such as a device registered to a particular user account), or access may be provided only to a particular device and if used by a particular user.

FIG. 5 illustrates one embodiment of a system 100. Digital content 102 such as audio files or music files may be stored in a database 102. A cloud-based DRM server platform 104 is shown which Is operatively connected to the database 102. A mobile device 106 or other type of computing device such as computer, tablet, laptop, television, entertainment device or the like may operatively connect with the DRM server platform 104 such as through the Internet or other network. The earpieces 10 may communicate with the DRM server platform 104 as well such as through a network. The earpieces 10 may communicate through the mobile device 106 to the DRM server platform or may otherwise connected to a network which allows for operative communication with the DRM server platform 104. A person 108 is also shown. The DRM server platform 104 may provide for digital rights management in various ways. For example, where digital content 102 includes audio files which are to be delivered to a user as audio files, the audio files may be encrypted. A specific audio file may be encrypted for a specific user 108 or user account associated with the user. Thus, only the specific user or someone with access to the user account of the user 108 may unencrypt of decrypt the audio files. Alternatively, a specific audio file may be encrypted for a specific device or set of devices such that on the specific device or a device amongst the set of devices or devices may encrypt or decrypt the audio files or portions thereof. Of course, encryption may be applied by the DRM server platform in other ways as well.

Instead of communicating audio files to the earpieces 10, one or more audio streams may be communicated to the earpieces 10. This may be accomplished in various ways, including through the DRM server platform 104 with the DRM server platform 104 encrypting the audio stream such that only an appropriate user or device may unencrypt the audio stream or portions thereof.

Therefore various examples of earpieces with digital rights management have been shown and described along with related methods. The present invention contemplates numerous variations, options and alternatives including the number of earpieces used, whether audio files are stored or streamed, the specific type of digital rights management processes or techniques applied, and other options, variations, and alternatives.

What is claimed is:

1. A wireless earpiece for digital rights management comprising:
an ear piece housing;
a processor disposed within the ear piece housing;
a speaker operatively connected to the processor;
a storage medium disposed within the ear piece housing and operatively connected to the processor; and
a wireless transceiver disposed within the ear piece housing and operatively connected to the processor;
wherein the processor is configured to access audio files stored on the storage medium to play the audio files using the speaker;
wherein the processor is configured to provide digital rights management for one or more of the audio files.

2. The wireless earpiece of claim 1 wherein the processor is configured to access an audio stream conveyed to the earpiece through the wireless transceiver.

3. The wireless earpiece of claim 2 wherein the processor is configured to provide digital rights management for the audio stream.

4. The wireless earpiece of claim 1 further comprising at least one sensor for detecting biometric information, the at least one sensor operatively connected to the processor.

5. The wireless earpiece of claim 4 wherein the processor is configured to verify an identity of a user using the biometric information from the at least one sensor.

6. The wireless earpiece of claim 1 wherein the audio files are encrypted and wherein the digital rights management provides for unencrypting the audio files for playback through the speaker if the wireless earpiece is authorized.

7. The wireless earpiece of claim 6 wherein the unencrypting of the audio files is performed using a device identifier associated with the wireless earpiece.

8. The wireless earpiece of claim 6 wherein the unencrypting of the audio files is performed using biometric information detected using at least one sensor of the earpiece, the at least one sensor operatively connected to the processor.

9. A wireless earpiece for digital rights management comprising:
an ear piece housing;
a processor disposed within the ear piece housing;
a speaker operatively connected to the processor;
a wireless transceiver disposed within the ear piece housing and operatively connected to the processor;
wherein the processor is configured to access an audio stream conveyed to the earpiece through the wireless transceiver;
wherein the processor is configured to provide a digital rights management feature for the audio stream.

10. The wireless earpiece of claim 9 further comprising at least one sensor for detecting biometric information, the at least one sensor operatively connected to the processor.

11. The wireless earpiece of claim 10 wherein the processor is configured to verify an identity of a user using the biometric information from the at least one sensor.

12. The wireless earpiece of claim 11 wherein the audio stream is encrypted and wherein the digital rights management feature provides for unencrypting the audio stream for playback through the speaker if the wireless earpiece is authorized.

13. The wireless earpiece of claim 12 wherein the unencrypting of the audio stream is performed using a device identifier associated with the wireless earpiece.

14. The wireless earpiece of claim 1 wherein the unencrypting of the audio files is performed using biometric information detected using at least one sensor of the earpiece, the at least one sensor operatively connected to the processor.

15. A method for using digital rights management in an earpiece, the method comprising:
providing an earpiece comprising an ear piece housing, a processor disposed within the ear piece housing, a speaker operatively connected to the processor, a storage medium disposed within the ear piece housing and operatively connected to the processor, and a wireless transceiver disposed within the ear piece housing and operatively connected to the processor;
unencrypting an audio file or an audio stream at the earpiece to provide for digital rights management; and
playing the audio file or the audio stream using the speaker.

16. The method of claim 15 wherein the step of unencrypting is performed using a device identifier for the earpiece.

17. The method of claim 15 wherein the step of unencrypting is performed using a user identifier associated with a user of the earpiece.

18. The method of claim 17 wherein identity of the user is verified using biometric data from at least one sensor operatively connected to the processor.
